(19) United States
(12) Patent Application Publication
(10) Pub. No.: US 2014/0280266 A1
(43) Pub. Date: Sep. 18, 2014

(54) SYSTEMS, METHODS, AND APPARATUSES FOR TRACKING THE DISPLAY OF MEDIA-BASED CONTENT IN REAL TIME

(71) Applicants: Craig Evan Walter, Houston, TX (US); Erica Michelle Walter, Houston, TX (US)

(72) Inventors: Craig Evan Walter, Houston, TX (US); Erica Michelle Walter, Houston, TX (US)

(21) Appl. No.: 13/798,996

(22) Filed: Mar. 13, 2013

(51) Int. Cl. G06F 17/30

(52) U.S. Cl. CPC G06F 17/30023
USPC 707/758

(57) ABSTRACT

Applicants have created systems, methods, and apparatuses for tracking the display of media-based content in real time. The inventions can include a first media device adapted to output media, a first display unit adapted to display the outputted media, and an apparatus adapted to receive metadata associated with the outputted media and compare the metadata with data. The apparatus can further be adapted to output the media and one or more of a warning indicator and a status indicator if at least a portion of the metadata and the data match as a result of the comparison of the metadata with the data. By tracking the display of media-based content, the inventions described herein can prevent an end user from accessing previously accessed media-based content, restrict the content a given end user is permitted to access, and ensure the licensing terms of a copyright owner's content are properly enforced.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to systems, methods, and apparatuses for tracking the display of media-based content in real time. In one of the aspects, the invention specifically relates to systems, methods, and apparatuses for tracking an end user's past viewing history of particular media-based content and comparing it with a present request to view the media-based content. In further aspects, the invention relates systems, methods, and apparatuses for monitoring and/or regulating the viewing habits of an end user, restricting the content a given end user is permitted to access, and ensuring the licensing terms of a copyright owner's content are properly enforced by restricting the duration and/or number of iterations particular copyrighted media-based content is accessed.

2. Description of the Related Art

The inventions disclosed and taught herein are directed to improved systems, methods, and apparatuses for tracking the display of media-based content in real time. Although these inventions can be used in numerous applications, the inventions will be disclosed in only a few of many applications for illustrative purposes.

Over the past decade, the availability of personal media recording and displaying devices, such as Digital Video Discs (DVDs), Digital Video Recorders (DVRs), etc., has increased dramatically. Among other things, these media devices provide end users with the luxury of rapid and relatively inexpensive access to a host of media-based content (such as movies, videos, music, pictures, etc.). Moreover, these media devices are often employed as permanent fixtures at particular locations in the residence of a given end user. For example, many end users enjoy watching television in their living rooms and/or bedrooms with the aid of a television and a video-based outputting device (such as a cable box that includes a DVR, a DVD player, etc.). Commonly, these end users can enjoy live streaming content (e.g., cable), time-shifted content (e.g., recording a television show on a DVR such that it may be viewed at a later time), and on-demand content (such as a movie embodied on a DVD).

Because end users have so many options in which to enjoy this media-based content, if is often difficult to keep track of which content a given user has already viewed at an earlier time. For example, a user may record multiple episodes of her favorite television show over a given time period. Because cable networks tend to repeat the broadcast of these episodes over time, end users often inadvertently rerecord the same episode of that given television at a later time. One drawback of the end user's ability to quickly and efficiently record this content, however, is that often it is not until after the user begins watching a portion of the rerecorded media until she realizes that she has already viewed it. This causes an inefficient use of storage space, wastes time, and further results in frustration of the end user.

Previous attempts to solve this problem are very limited. For example, often cable providers will include an interface with their DVR units that can indicate whether or not the particular content has been viewed for that particular recording. In other words, after the content is stored, the interface will provide a notification that a user attempted to access the recording. The drawback to this solution, however, is that this primitive notification system will not account for content that was previously viewed, deleted, and rerecorded, as is commonly practiced by users of today's DVR systems.

Moreover, this solution is limited in the sense that it only provides a binary-type notification (i.e., whether a portion of the content was viewed or not). These notifications do not indicate when the content was accessed, by whom it was accessed, what exact, particular portions of the content was accessed, etc. Furthermore, these notifications are limited to the content received from the cable provider. In other words, these notifications will not track content accessed or viewed through other media-accessing units, such as DVD players, computers, VHS recorders, video games, streaming video, such as NETFLIX®, HULU®, etc.

What is required, therefore, are systems, methods, and apparatuses that are capable of tracking the display of any type of media-based content, accessed through any type of media accessing device, at any given period of time to prevent an end user from unnecessarily recording and/or viewing content that he has previously viewed. Accordingly, the inventions disclosed and taught herein are directed to systems, methods, and apparatuses that overcome the problems as set forth above.

### BRIEF SUMMARY OF THE INVENTION

Applicants have created systems, methods, and apparatuses for tracking the display of media-based content in real time. The inventions can include a first media device adapted to output media, a first display unit adapted to display the outputted media, and an apparatus adapted to receive metadata associated with the outputted media and compare the metadata with data. The apparatus can further be adapted to output the media and one or more of a warning indicator and a status indicator if at least a portion of the metadata and the data match as a result of the comparison of the metadata with the data. By tracking the display of media-based content, the inventions described herein can prevent an end user from accessing previously accessed media-based content, restrict the content a given end user is permitted to access, and ensure the licensing terms of a copyright owner's content are properly enforced.

The system for tracking the display of media-based content in real time can include a first media device that can be adapted to output media, a first display unit that can be adapted to display the outputted media, and an apparatus that can be adapted to receive metadata associated with the outputted media and compare the metadata with data. The metadata associated with the outputted media can be stored as additional data for subsequent comparison with additional metadata. The apparatus can be adapted to output the media and one or more of a warning indicator and a status indicator if at least a portion of the metadata and the data match as a result of the comparison of the metadata with the data.

Further, the system's apparatus can include a first database adapted to store the data and the system can include a server that is adapted to store predetermined data to be compared with the metadata. The system can further include a camera that can be adapted to receive an input for generating a portion of the metadata and a remote device that can further include one or more of a first signal indicator, a second signal indicator, an output device, or a biometric device. The camera can further be coupled to a facial recognition application and the portion of the metadata can include an identity of an end user viewing the media-based content.

The computer readable storage medium configured to store a program for tracking the display of media-based content in real time can include a program that is adapted to execute instructions for performing steps. The instructions can include the step of receiving metadata associated with media outputted by a first media device, comparing the metadata associated with the outputted media with data, outputting one or more of a warning indicator and a status indicator if at least a portion of the metadata and the data match as a result of the comparing step, and displaying the media and the one or more of a warning indicator and a status indicator through a first display unit if the metadata and the data match.

The receiving step can further include storing the metadata associated with the outputted media as additional data for subsequent comparison with additional metadata, and the additional metadata can be adapted to be received upon a request for media to be displayed through the first display unit. The instructions can further include the step of requesting media to be displayed through the first display unit that can be initiated by an end user. The instructions can further include the step of receiving an end user's metadata, wherein the end user's metadata is adapted to be stored with the data and the step of comparing at least one metadata block with the data, wherein the metadata block can include one or more of the following: type of media, title of media, or sub-title of media.

The instructions can further include the step of determining the presence of an end user within a given proximity of the first display unit throughout the display of media and generating data associated with the determination of the end user's presence, the step of generating a report based on the comparing step, wherein the report is adapted to output information from one or more metadata blocks that include the metadata, and the step of displaying at least a portion of the report through a social media site. Lastly, the displaying step can include prompting a user to enter a password prior to displaying the media and after displaying the one or more of a warning and an indicator.

The method for tracking the display of media-based content in real time can include the step of receiving media from a first server through a network, wherein the received media can be adapted to be stored in a first computer readable storage medium on a first media device. The method can further include the step of requesting the received media to be displayed through a first display unit, wherein the requesting step can be performed by an end user's operation of a remote device. Still further, the method can include the step of receiving metadata associated with the received media stored in the first computer readable storage medium and the step of comparing the metadata associated with the received media with data stored in a second computer readable medium to determine whether or not at least a portion of the metadata and the data match.

Furthermore, the method can include the step of outputting one or more of a warning indicator and a status indicator if at least a portion of the metadata and the data match as a result of the comparing step and the step of displaying the media and the one or more of a warning indicator and a status indicator through a first display unit if and only if the metadata and the data match. Finally, the method can include the step of storing the data in the second computer readable storage medium as additional data irrespective of whether or not at least a portion of the metadata and the data match wherein the data and the additional data can be adapted to be compared with the additional metadata upon a subsequent request to receive media to be displayed through the first display unit.

### BRIEF DESCRIPTION OF THE SEVERAL VIEWS OF THE DRAWINGS

The following Figures form part of the present specification and are included to further demonstrate certain aspects of the present invention. The invention may be better understood by reference to one or more of these Figures in combination with the detailed description of specific embodiments presented herein.

FIG. 1A illustrates a first embodiment of the system for tracking the display of media-based content in real time.

FIG. 1B illustrates a second embodiment of the system for tracking the display of media-based content in real time.

FIG. 2A illustrates an embodiment of a media data structure.

FIG. 2B illustrates a detailed view of the metadata illustrated in FIG. 2A.

FIG. 3 illustrates an embodiment of warning and status indicators to be displayed on a first display unit.

FIG. 4 illustrates an embodiment of the remote device illustrated in FIG. 1A.

FIG. 5 illustrates an embodiment of the portable apparatus adapted to be used in conjunction with the system for tracking the display of media-based content in real time.

FIG. 6A illustrates a flow diagram depicting a first embodiment of exemplary instruction steps for carrying out a method for tracking the display of media-based content in real time.

FIG. 6B illustrates a flow diagram depicting a second embodiment of exemplary instruction steps for carrying out a method for tracking the display of media-based content in real time.

FIG. 6C further illustrates the flow diagram depicting the second embodiment of exemplary instruction steps for carrying out a method for tracking the display of media-based content in real time as illustrated in FIG. 6B.

FIG. 7 illustrates a flow diagram depicting a method for tracking the display of media-based content in real time.

While the inventions disclosed herein are susceptible to various modifications and alternative forms, only a few specific embodiments have been shown by way of example in the drawings and are described in detail below. The Figures and detailed descriptions of these specific embodiments are not intended to limit the breadth or scope of the inventive concepts or the appended claims in any manner. Rather, the Figures and detailed written descriptions are provided to illustrate the inventive concepts to a person of ordinary skill in the art and to enable such person to make and use the inventive concepts.

### DETAILED DESCRIPTION

Applicants have created systems, methods, and apparatuses for tracking the display of media-based content in real time. The inventions can include a first media device adapted to output media, a first display unit adapted to display the outputted media, and an apparatus adapted to receive metadata associated with the outputted media and compare the metadata with data. The apparatus can further be adapted to output the media and one or more of a warning indicator and a status indicator if at least a portion of the metadata and the data match as a result of the comparison of the metadata with the data. By tracking the display of media-based content, the inventions described herein can prevent an end user from accessing previously accessed media-based content, restrict the content a given end user is permitted to access, and ensure the licensing terms of a copyright owner's content are properly enforced.

FIG. 1A illustrates a first embodiment of the system for tracking the display of media-based content in real time. FIG. 1B illustrates a second embodiment of the system for tracking the display of media-based content in real time. These Figures will be described in conjunction with one another.

The system 10 for tracking the display of media-based content in real time can include a first media device 12 that can be adapted to output media, a first display unit 14 that can be adapted to display the outputted media, and an apparatus 16 for tracking the display of media-based content in real time (referred to throughout this disclosure simply as “apparatus 16”) that can be adapted to receive metadata associated with the outputted media and compare the metadata with data.

First media device 12 can include a cable programming receiving unit (such as a commercially available cable box with or without a DVR unit), a DVD player, a computer (such as a laptop), a video game console, a CD player, a docking unit for a device for playing mp3 or other audio files (such as, for example, an IPOD®, ANDROID®, an IPAD®, an IPHONE®, etc.), or any other device for receiving and/or transmitting media-based content, such as pictures, audio, video, music, movies, television shows, or the like.

First media device 12 is adapted to output media-based content (such as one or more types of media (e.g., video, music, movies, television programming, or the like)) and metadata as described in greater detail below. For example, as an end user requests media-based content (for example, requesting to watch a movie previously recorded on the first media device 12), the media-based content and the metadata can be transmitted to the apparatus 16 and the media-based content can be transmitted to the first display unit 14.

Alternatively, the media-based content can be transmitted to the apparatus 16 and the apparatus 16 can generate metadata based on the media-based content. In this example, the media-based content is transferred to the first display unit 14 so that the end user can view the requested media while the apparatus 16 either processes the metadata, or generates the metadata associated with the particular media-based content.

The first display unit 14 can include one or more televisions (such as LED, LCD, plasma, etc.), monitors, projector screens, and/or any other display device for outputting data, pictures, videos, graphic, or the like. For example, first display unit 14 can include any device adapted to convey, project, output, and/or display data or information received from an electronic device. In a further example, first display unit 14 can include a surface, such as a wall—which video can be displayed upon—that is adapted to convey the projected data, image, or the like to an end user.

As the media-based content is being projected, outputted, displayed, etc. on the first display unit 14, apparatus 16 is adapted to track the display of the content. For example, apparatus 16 can be coupled to first display unit 14 such that it actively monitors and/or records the media being displayed on the first display unit 14 in real time. This monitoring can occur whether or not the first display unit 14 is even turned on. For example, apparatus 16 is adapted to receive a flag (not shown) such as a semaphore, bit, or the like, that indicates whether or not the first display unit 14 is on or off. With this flag (not shown), the apparatus 16 is capable of determining whether or not the requested content is actually being viewed by an end user.

Apparatus 16 can include an apparatus for tracking the display of media-based content in real time. For example, apparatus 16 can include a device, such as a computer that is adapted to receive inputs (such as, for example, data and metadata), transmit outputs (such as, for example, warnings, indicators, etc.). Apparatus 16 can further include a memory, (such as, for example, all or a portion of first database 17) or, in the alternative, apparatus 16 can be adapted to communicate with a memory that is not located as part of apparatus 16. Furthermore, apparatus 16 can include a processor, CPU, and/or arithmetic logic unit for processing data (such as, for example, performing a comparison of received data and/or metadata with stored data and/or metadata) as described in greater detail below.

Further, the system's 10 apparatus 16 can include a first database 17 adapted to store the data and the system 10 can include a first server 22 that is adapted to store predetermined data to be compared with the metadata. The first database 17 can include any set and/or collection of data that is organized in a particular form and/or structure (e.g., as a data structure). Alternatively, first database 17 can include data stored in a random, unorganized form. First database 17 can store a set of data, or in the alternative, a single datum.

First database 17 can include a single storage medium (such as, for example, the computer readable storage medium described below) or it can include multiple storage media devices. Although first database 17 is illustrated as being located solely on a single element (e.g., apparatus 16), first database 17 can be divided between or among multiple apparatuses and/or systems. For example, a first portion of database 17 can be located within apparatus 16 and a second portion can be located within first media unit 12. Other configurations, though not specifically described herein, are contemplated as well.

The apparatus 16 can operate in “tracking mode,” “notification mode,” “input mode,” and/or “restricted access mode.” For example, in “tracking mode,” if an end user requests the playback of media (such as, for example, a television episode from an online streaming service provider, e.g., HULU®), an end user can request the episode (e.g., with the aid of the remote device 20 as described in greater detail below) to be projected, displayed, outputted, etc. on the first display unit 14. As the episode is being displayed on the first display unit 14, the apparatus 16 can track the content being displayed along with any associated metadata.

One or more of these metadata and data can be stored in the apparatus 16 (for example, first database 17). In other words, metadata can be both generated from the content being viewed (e.g., the amount of time the media is being displayed and/or outputted to the first display unit 14) and obtained from the content being viewed (e.g., storing the metadata already associated with the particular content, for example, the metadata that HULU® transmits along with the television program being displayed) in real time, as the media is being played back to the end user.

The end user can establish settings and/or preferences for each of “tracking mode,” “notification mode,” “input mode,” and “restricted access mode.” For example, in “tracking mode,” an end user can set up the apparatus 16 so that it automatically tracks every program displayed by, and/or outputted to, the first display unit 14. Alternatively, an end user can set preferences to only track certain media, media outputted from particular media devices (such as, for example, first media unit 12), etc.

In fact, these settings can include any of the metadata described in conjunction with FIGS. 2A and 2B below. Still further, these modes can be set on a case-by-case and/or manual basis such that every time an end user requests playback of media-based content, she is prompted with a menu and/or display on either the remote device 20 and/or first display device 14 asking whether or not apparatus 16 should be set to track the display and/or output of that particular media.

In another example, if an end user requests the playback of media (such as a movie stored on a DVR device) previously recorded on the first media device 12, and turns the first display unit 14 off halfway through the movie while it is playing, apparatus 16 can determine and memorialize the moment in the playback in which the first display unit 14 was turned to the “off” position. This determination can be recorded as data (for example, along with the data already stored in the first database 17 of the apparatus 16 used to compare with metadata as described in greater detail below).

In this example, even though the end user can forgot to turn off the playback of the media after he turned off the first display unit 14, he can return to the exact point in which he stopped viewing the content based on the information and/or data stored in the apparatus 16. A similar mechanism can be employed based on a determination of whether or not the end user exits a room and/or exceeds a given proximity from the first display unit 14 as described in greater detail below.

In “notification mode,” apparatus 16 can be configured to track media and/or metadata as described above in conjunction with the “tracking mode”. In addition, in “notification mode,” apparatus 16 can compare the metadata associated with outputted media (for example, the television program transmitted by the HULU® service described above) with data. The data described can be data stored in the first database 17 of apparatus 16. For example, as the apparatus 16 tracks the media being outputted and/or displayed, it can store the metadata as data.

Subsequently, as the end user requests additional media-based content to view, display, or the like, the previous metadata (now stored as data, for example, on apparatus 16) is compared with the metadata associated with the presently requested media-based content to determine if a match occurs or not. This is described in greater detail below in conjunction with FIGS. 2A, 2B, 6B, and 6C. If a match occurs as a result of this comparison (for example, some or all of the metadata match), a warning indicator 304 (e.g., FIG. 3) and/or a status indicator 306 (e.g., FIG. 3) can be outputted and/or displayed (for example, on the first display unit 14, remote device 20, etc.) as described in greater detail below.

In “input mode,” an end user (or alternatively a program, script, computer, etc.) can be used to manually populate the data stored by apparatus 16 (for example in the first database 17). In this mode, an end user can manually enter data associated with particular media-based content to mimic the data and/or metadata received and/or stored by apparatus during “tracking mode.” For example, “input mode” can serve as a “do not play” list that can be used, for example, for parental controls. In this example, media that was not even previously outputted and/or displayed can trigger the notification process described above before an end user even requests the media-based content for the first time.

For example, if an end user would like to restrict a particular movie title, the end user can manually enter the movie title into the apparatus 16 while in input mode, and the apparatus 16 can populate the entered data into the first database 17 as data that can be compared with a subsequent request for media-based content. As described in greater detail below, this will result in additional metadata to be stored with the data stored in first database 17 as a result of the end user's manual population of that particular media.

Additionally, in “input mode,” a user can manually enter start and stop times for particular media. For example, if an end user knows she is going to miss a portion of the media she is presently viewing, she can enter multiple start and/or stop times that can be stored as data associated with the media-based content. In this example, an end user can transmit one or more inputs, such as bookmarks, to apparatus 16 (e.g., start and stop points throughout the media) so that he can quickly return to those bookmarked locations. This feature can be used to save a location or locations of particular media-based content to easily locate later or to establish points of demarcation that can “bookend” a portion of the media. This can be useful, for example, if an end user knows he will be unable to view a portion of the media and he would prefer a quick and efficient way of finding the exact segment of media that he missed.

In “restricted access mode,” once a match occurs, the apparatus can restrict the end user from viewing, displaying, outputting, etc. the media-based content once a match occurs as described in greater detail below. For example, the display, output, viewing, etc. of the requested media can be partially or fully restricted. In one example, when fully restricted, the media cannot be accessed. This mode can be evoked, for example, if an end user purchases a license to view content (for example, an on-demand movie that employs a “time-bomb” license that restricts the amount of time from the time of purchase in which the end user can view and/or otherwise access the content).

When partially restricted, portions of the content can be restricted or, in the alternative, the entire content can be restricted such that the restricted access can only be lifted with the input of a key and/or password. For example, in partially restricted mode, the end user can be prompted to enter a password before the content can be viewed. In another example, the end user can be prompted to enter payment information (such as credit card information) before the media-based content can be accessed. Through the use of these passwords and other restriction-based prompts, the media-based content owner can avail itself of further safeguards for preventing an user end from violating and/or exceeding particular copyright licenses issued for accessing the media-based content.

Apparatus 16, though depicted in FIGS. 1A and 1B as a standalone device, can, in other embodiments, be incorporated in one or more of the other elements disclosed in these two Figures. For example, apparatus 16 can be incorporated into first display unit 14. Alternatively, apparatus 16 can be divided between or among multiple devices (e.g., first database 17 can be located in first media unit 12 and the remaining components of apparatus 16 can be located on a server (not shown) that is remotely located from the remaining components (e.g., at a third-party location or site).

Apparatus 16 can be connected to one or more of the remaining elements through various connection types that can be wired, wireless, or any combination thereof. Although FIGS. 1A and 1B illustrate apparatus 16 as being coupled to other elements through first connection 18, other connection configurations are contemplated as well.

First connection 18 can include any connection (e.g., wireless, wired, or a combination thereof) for permitting the transfer of data, metadata, or other information from a first location to a second location. For example, first connection 18 can include a wired connection (e.g., coaxial cable) for connecting first media device 12, first display unit 14, and apparatus 16. In another example, first connection 18 can be wireless. In a further example, although not explicitly illustrated in the Figures, first connection 18 can incorporate and/or replace other connections disclosed (such as, for example, second connection 24), or it can connect other elements of FIGS. 1A and 1B to one another (for example, first server 22, remote device 20, etc.).

Remote device 20 can include a controller, such as a remote controller, or any other device (such as a handheld device) for controlling one or more of the elements described in conjunction with system 10. For example, remote device 20 can include a universal remote control for controlling the first media device 12, first display unit 14, and apparatus 16. The remote device 20 can include a touch-based interface (such as, for example, an end user's input can be provided through a series of buttons, one or more touchscreens, or another touch-based user interface).

Alternatively, remote device can be used to control one or more of the elements described in conjunction with FIGS. 1A and 1B through aural-based and/or voice-based commands. The remote device 20 can be wireless (as illustrated in the Figures, or in the alternative, wired to one or more other elements of system 10). Remote device 20 can further include a handheld portable device, such as a cellular phone. In this example, the phone's user interface can be employed to operate and/or control one or more of the elements described in conjunction with FIGS. 1A and 1B. Other features of remote device 20 are described below in conjunction with FIG. 4, below.

Furthermore, remote device 20 can be used to communicate directly with first server 22 without the need for first server 22 to communicate with first media device 12. For example, if first server 22 includes an on-demand-type service (such as VUDU®), the remote device 20 can be used, in one example, to communicate directly with first display device 14 which, in turn, can communicate with first server 22. In this example, remote device 20 can be used to access media-based content originating from first server 22.

First server 22 can include any server adapted to process, manipulate, and/or store data. The first server 22 can include one or more servers, each including one or more databases (not shown). In an exemplary and non-limiting illustrative embodiment, first server 22 can include the server of a service provider, such as the broadcast station of cable service provider. In this embodiment, first server 22 can include the computers, systems, storage areas, etc. of the service provider in the broadcast station from which the provider transmits media, such as cable programming.

Additionally, first server 22 can include the computers, systems, storage areas, etc. of a satellite media provider, such as satellite television. In this example, the first server 22 can include the satellite service's broadcast station that originates the programming to be relayed to a satellite before it is received by the first media device 12. In this example, the satellite and a satellite signal receiving device (such as a satellite dish (not shown)) can communicate through second connection 24, or in the alternative, the connection between the satellite signal receiving device (not shown) and the first media device 12 through second connection 24.

Second connection 24 can include one or more of the examples, descriptions, and/or embodiments of first connection 18 described above. For example, second connection 24 can include one or more wireless connections between or among two or more elements of system 10. Although FIGS. 1A and 1B depict second connection 24 as coupling first server 22 to first media device 12 in one example, and network 36 to first server 22 in another example, other combinations and/or permutations of connections between and among the elements of system 10—although not specifically illustrated—are contemplated as well. In one example, second connection 24 can be used to connect first server 22 to first storage medium 26, without the need for first server 22 to communicate with first media device 12 (for example, when first display unit 14 includes first storage medium 26).

First storage medium 26 can include one or more memories for storing data and/or metadata. For example, first storage medium 26 can include a hard drive for storing movies and/or televisions shows received by first server. Although depicted in FIGS. 1A and 1B as being part of first media device 12, first storage medium 26 can be located, in the alternative, at a location other than within first media device 12. In this example, the data, media, metadata, or the like stored can be accessed by first media device 12 from a location external to it.

Similarly, computer readable medium 28 can include one or more memories for storing data and/or metadata to be accessed and/or manipulated by apparatus 16. Likewise, computer readable medium 28 can be located within apparatus 16, or in the alternative, at a location external to apparatus 16 so that apparatus 16 can still read, write, manipulate, or otherwise access the information, data, media-based content, and/or metadata stored therein.

The computer readable medium 28 can include any medium that that can be used in conjunction with the computer readable instructions, programs, or applications, such as, for example, the applications and/or programs described in conjunction with the process steps described in greater detail below. These applications, programs, etc. can include firmware, software, hardware, or any combination thereof for instructing a computer or other electronic device for performing and/or carrying out a series of steps and/or instructions.

The computer readable instructions can include any code and/or instruction that is adapted to be read by a computer, such as, assembly, machine, executable, non-executable, compiled, or uncompiled code, or any other instructions adapted to be read by a computer or electric device with an arithmetic logic unit.

In an exemplary and non-limiting illustrative embodiment, the computer readable medium 28 can include a computer readable storage medium (“CRSM”). The computer readable storage medium can take many forms, including, but not limited to, non-volatile media and volatile media, floppy disks, flexible disks, hard disks, magnetic tape, other magnetic media, CD-ROMs, DVDs, or any other optical storage medium. Computer readable storage media can further include RAM, PROM, EPROM, EEPROM, FLASH, combinations thereof (e.g., PROM EPROM), or any other memory chip or cartridge.

The computer readable medium 28 can further include a computer readable transmission medium (“CRTM”). These transmission media can include coaxial cables, copper wire, and fiber optics. Transmission media may also take the form of acoustic or light waves, such as those generated during radio frequency, infrared, wireless, or other media comprising electric, magnetic, or electromagnetic waves. Although not explicitly illustrated in the Figures, computer readable media 28, such as one or more of the CRTM, can be used as constituent components in forming one or more of the databases (such as, for example, first database 22 and/or second database 30).

Several variations for the instructions stored on a computer readable storage medium are contemplated, as illustrated by the following examples without specific reference to the Figures.

The computer readable storage medium (“CRSM”) can be configured to store a program for tracking the display of media-based content in real time, wherein the program is adapted to execute instructions for performing the following steps, comprising receiving metadata associated with media outputted by a first media device; comparing the metadata associated with the outputted media with data; outputting one or more of a warning indicator and a status indicator if at least a portion of the metadata and the data match as a result of the comparing step; and displaying the media and the one or more of a warning indicator and a status indicator through a first display unit if the metadata and the data match.

The receiving step further comprises storing the metadata associated with the outputted media as additional data for subsequent comparison with additional metadata. The additional metadata is adapted to be received upon a request for media to be displayed through the first display unit. The instructions can perform the step comprising requesting media to be displayed through the first display unit, wherein the step of requesting media to be displayed through the first display unit is initiated by an end user. The comparing step further comprises comparing at least one metadata block with the data, wherein the metadata block comprises one or more of the following: type of media, title of media, or sub-title of media. The displaying step further comprises prompting a user to enter a password prior to displaying the media and after displaying the one or more of a warning and an indicator.

The instructions can perform the step comprising determining the presence of an end user within a given proximity of the first display unit throughout the display of media and generating data associated with the determination of the end user's presence. The data associated with the determination of the presence of an end user is adapted to reflect at least one start time and at least one end time in which the end user was not located within the given proximity of the first display unit. The instructions can include the step comprising generating a report based on the comparing step, wherein the report is adapted to output information from one or more metadata blocks that comprise the metadata. The instructions can perform the step comprising displaying at least a portion of the report through a social media site and the step comprising receiving an end user's metadata, wherein the end user's metadata is adapted to be stored with the data.

Second database 30 can include one or more of the examples, descriptions, and/or embodiments of first database 17 described above. For example, second database 30 can include one or more sets or collections of data. In particular, in an exemplary and non-limiting illustrative embodiment, second database 30 can include data and/or metadata that is predetermined (such as, for example, manually entered by an end user at an earlier point in time). In this embodiment, the data stored in second database 30 can be maintained for comparison irrespective of the data and/or metadata stored in first database 17.

In other examples, metadata can include the metadata previous encoded, stored, and/or otherwise associated with particular media. For example, often DVDs store pre-encoded metadata reflecting the move title, chapter titles, menus, etc. Moreover, media received through a cable box, such as satellite television, often reflects information about the programming (such as the title, names of actors and actresses, original broadcast date, rating (e.g., five stars), MPAA rating (e.g., PG-13), and so on. These metadata can be employed, for example, by apparatus 16, and used for comparison and discussed in greater detail below.

Alternatively, these metadata can be generated, such as with the use of apparatus 16. In this particular example, apparatus 16 can generate several aspects of the metadata either through comparison with a database (such as, for example, second database 30) or through an application that is capable of ascertaining certain attributes of the media (e.g., facial recognition of the actors and/or actresses, etc.).

In an exemplary and non-limiting illustrative embodiment, second database 30 can be employed as a “do not access” list. For example, an end user can manually enter the names of television shows, movies, etc. that she wishes to be populated into the second database 30 to be used for comparison as described in conjunction with the “restricted access mode” described above (e.g., end user manually enters a media title, category, etc. into second database 30). Alternatively, the end user can enter this information directly into first database 17.

In still another example, end user can obtain predetermined individual and/or prepackaged lists of media content. In this example, the end user can purchase or otherwise obtain large collections of media in which the end user desires to already be stored in second database 30 to ensure that apparatus 16 will successfully match during either “notification mode” or “restricted access mode” as described above. For example, for parental controls, an end user can obtain a list of all R-rated movie titles. In this example, if an end user attempts to display, output, view, etc. a particular R-rate movie title, the title will be compared (and subsequently matched) with the data stored in the second database 30 containing the list of R-rated movies, thus trigging the notification and/or restricted access process described above. In another example, all types of media, such as video games, can be populated in second database 30.

In this example, the end user would not be able to play a particular video game or any video game if a match occurs. The second database 30, therefore, can serve as an even broader “do not play” list that is configured to cover broad, sweeping categories of media in which the end user wishes a match to occur, without requiring the end user to manually enter these metadata in the second database 30.

In addition to the second database 30 described above, additional components of system 10 can be incorporated as well. For example, second media device 32 and third media device 34 can include one or more of the examples, descriptions, and/or embodiments of first media device 12 described above. In an exemplary and non-limiting illustrative embodiment, first media device can include a DVD player, second media device 32 can include a DVR device (such as TIVO®), and third media device 34, can include an auxiliary input device (such as a laptop with an auxiliary output to display the contents of its screen onto the first display unit 14. Other examples are contemplated as well.

Alternatively, one or more of the first, second, and third media devices 32, 34, and 36, respectively, can include the device and/or server (not shown) that originates Internet-based streaming media content. For example, if an end user streams live movies through a web-based service such as NETFLIX®, these media devices (e.g., 32, 34, and 36) can include the devices (e.g., servers, memories, etc.) that store and/or transmit the media-based content that the end user receives from the particular service provider. These elements can be coupled to one another through first connection 18, second connection 24, network 36, or any combination thereof.

Network 36 can include one or more networks that are wireless, wired, or a combination thereof. For a wired-type network 36, cables, wires, optical fibers, etc. (such as “hard-wired” electrical components) can be adapted to couple one or more elements of the system 10 to one another, such as, for example, with a physical connection. For a wireless-type network 36, one or more elements disclosed in FIGS. 1A and 1B can communicate with the network 36 over wireless, infrared, radio frequencies, or the like. Examples of wireless-type networks 36 can include BLUETOOTH® connections, WiFi connections, or other electromagnetic waves and/or signals capable of wirelessly transmitting and/or receiving data between one or more elements disclosed (such as those elements illustrated in FIG. 1B). Although not explicitly shown in the Figures, network 36 can be employed to connect elements in the Figures not explicitly illustrated as being connected by network 36, such as for example, camera 38.

Camera 38 can include any camera, camcorder, or other visual recording device for taking still photographs, motion pictures, or any combination thereof. For example, camera 38 can include any device that includes a lens and aperture controlled by a shutter. In an exemplary and non-limiting illustrative embodiment, camera 38 can include a camera coupled to a mobile phone or other hand-held and/or portable electronic device for taking photos or video clips. In the example of a mobile phone, the camera 38 in the phone can be triggered (e.g., taking a snapshot photo, starting and/or stopping video recording, etc.) though the mobile phone's standard communication interfaces (such as its 3 G protocol, 4 G protocol, WiFi, BLUETOOTH®, etc., and/or its application programming interface). Additionally, the camera 38 can be triggered through the aid of the remote device 20. Still further, the camera 38 can be triggered automatically based on optical recognition, motion sensing, or the like.

The camera 38 can be adapted to receive an input for generating a portion of the metadata. Furthermore, camera 38 can be coupled to a facial recognition application (not shown) and the portion of the metadata can include an identity of an end user viewing the media-based content. By using this facial recognition software application, camera 38 can send information to apparatus 16 for processing the information to generate data for determining the identity of the end user. The identity of the user then can be stored with other data that is generated from the metadata associated with that particular media.

For example, if an end user is watching a particular movie, camera 38 can record (either through still photography, video, etc.) the face of the end user, and store that information along with the metadata of that particular movie as data. At a later time, if an end user (either the original end user or another end user) attempts to view the same movie, the apparatus 16 can compare metadata of the movie with the stored data (now containing the previous end user's identity) and notify the end user to restrict access according to one or more settings and/or preferences.

For example, the apparatus 16 can be programmed to only notify the end user of the subsequent request if the end user of the subsequent request is the same as the end user of the original request. This feature can be employed to prevent a particular end user from re-watching particular media-based content or to track viewership by a particular end user. In order to setup the facial recognition application, each end user can request that camera 38 record each of their particular facial features so that their identities can be quickly ascertained when requesting media-based content.

Additionally, camera 38 can be used to determine the presence of an end user within a given proximity of the first display unit 14, the camera 38, and/or other elements illustrated in FIGS. 1A and 1B. For example, preferences and/or attributes can be established such that apparatus 16 can automatically track when a particular end user (or, any end user in general without reference to their particular identity) exceeds a particular proximity from one or more of these elements. For example, an end user can establish a radius from the first display unit 14 from which the apparatus 16 will determine the end user as being “not present” if that radius is exceeded.

This can happen, for example, if the end user leaves the room in which the first display unit 14 is located for a period of time. In this example, once the proximity radius has been exceeded, the apparatus 16 can receive and/or generate information on the start and stop times for which that particular end user is outside the given radius. These start and stop times can be stored along with the data that is stored from the metadata received on the particular media-based content currently being displayed.

With this feature, an end user can leave the room without fear of missing a particular portion of the media-content she is enjoying and further without resorting to pausing and/or suspending the media from being displayed. Alternatively, more than one camera 38 can be employed (e.g., one for each display unit) such that the appropriate information can be recorded, generated, and/or stored if an end user leaves the given proximity of the first display unit 14 and enters the proximity of a second display unit 40.

Second display unit 40 can include one or more of the examples, descriptions, and/or embodiments of first display unit 14 as described above. In one example, first display unit 14 can include a television in a first room of a house and the second display unit 40 can include a second television in another room of the house. For example, by employing at least two display units (e.g., first display unit 14 and second display unit 40), data can be stored, generated, and/or recorded about each particular display unit. This way, apparatus 16 can track the display of media-based content by the particular device outputting the given media-based content. In addition to the first display unit 14 and second display unit 40, apparatus 16 can track the output, display, etc. of this media to other elements of FIGS. 1A and 1B, such as, for example, computer 42.

Computer 42 can include any laptop, netbook, notebook, mp3 player (such as, for example, an IPOD®, tablet device (e.g., an IPAD®), e-reader, cellular phone, PDA, or other electronic device with an input, output, memory, and a processor and/or arithmetic logic unit.

Additionally, computer 42 can be used to output a report (not shown) generated by apparatus 16 that summarizes particular aspects of the data related to particular media-based content. For example, an end user can set preferences and/or settings in apparatus 16 to generate a report when particular media-based content is received (such as, for example, a live television show through a cable reception box), but not yet displayed. In this particular example, if an end user misses a live show, apparatus 16 can generate a report on a given-basis (e.g., daily, weekly, monthly, by content, by media type, etc.) to allow the end user to quickly determine which media-based content she missed during that particular report. The report can additionally be integrated with social media, such as TWITTER®, FACEBOOK®, etc. to automatically generate information through these social media sites to output one or more pieces of information contained within the report.

For example, if an end user misses the latest episode of a particular show, a report can be automatically generated and shared through FACEBOOK® to indicate that that particular end user missed that particular episode. This report-generating process and sharing process can, therefore, inform others that the particular end user missed the show, to give those recipients of the information through social media the opportunity to restrict their discussion on the topic so as to not reveal any information about the missed media-based content. Furthermore, filters can be integrated with the particular social media such that particular keyword will automatically be filtered and obscured from the end user so that any such “spoilers” will be automatically suppressed and/or concealed from the end user on that particular social media site.

Other variations of the system for tracking the display of media-based content in real time are contemplated as well, as illustrated by the following examples without specific reference to the Figures.

The system for tracking the display of media-based content in real time can comprise a first media device adapted to output media; a first display unit, wherein the display unit is adapted to display the outputted media; and an apparatus adapted to receive metadata associated with the outputted media and compare the metadata with data; wherein the apparatus is adapted to output the media and one or more of a warning indicator and a status indicator if at least a portion of the metadata and the data match as a result of the comparison of the metadata with the data.

The system can further comprise a first database adapted to store the data. The system can further comprise a remote device, wherein the remote device further comprises one or more of a first signal indicator, a second signal indicator, an output device, or a biometric device. The system can further comprise a server wherein the server is adapted to store predetermined data to be compared with the metadata. The system can further comprise a camera, wherein the camera is adapted to receive an input for generating a portion of the metadata. The camera is adapted to be coupled to a facial recognition application and the portion of the metadata comprises an identity of an end user viewing the media-based content. The system's metadata can be associated with the outputted media and be stored as additional data for subsequent comparison with additional metadata.

FIG. 2A illustrates an embodiment of a media data structure. FIG. 2B illustrates a detailed view of the metadata illustrated in FIG. 2A. These Figures will be described in conjunction with one another.

Media data structure 200 can include any data structure, such as linked lists, b-trees, binary trees, heaps, stacks, queues, hash tables, red-black trees, binomial heaps, Fibonacci heaps, etc., that can include one or more of metadata 202 and media data 204. Metadata 202 can include any, tags, blocks, data (structural, functional, or a combination thereof) for providing additional information about the data from which it is associated, and media 204 can include the media-based content, such as pictures, music, audible files, video, movies, television shows, video game content, etc.

In one particular example, metadata 202 can include data that describes attributes and/or characteristics of media-based content data (e.g., type of media, length of data, and/or media, etc.). Other examples of metadata 202 that can be associated with media data can include media type, media sub-type, media title, media sub-title, date tracked, date of original broadcast/output, requester(s) of media, length of media viewed, total length of media, percent viewed-to-total length, display unit device identification, media device identification, media origination, number of times media was displayed, etc.

The examples of metadata 202 described above can, in one particular embodiment, be divided into one or more metadata blocks 206a-206g. Although seven of such blocks are illustrated in FIG. 2B, more and/or fewer of such blocks are contemplated as well. With reference to the particular examples above, each block 206a-206g can include one or more of the exemplary metadata 202 discussed above.

For example, block 206a can store the Media Type (e.g., DVD), block 206b can store the Media Sub-Type (e.g., Blu-ray), block 206c can store the Media Title (e.g., American Beauty), block 206d can store a Date/Time Stamp (e.g., Jan. 31, 2013), block 206e can store the End User (e.g., CEW), block 206f can store the Output Device Identification (“Output Device ID”) (e.g., LR DVD), and block 206g can store the Display Unit Identification (“Display Unit ID”) (e.g., LR TV). In this particular example, metadata 202—as populated in accordance with the description above-would indicate that on Jan. 31, 2013, end user CEW watched a Blu-ray DVD version of “American Beauty” on a DVD player in a living room, displayed on a television located in the living room.

Although not explicitly illustrated, other metadata are contemplated as well (for example, Media Sub-Title (e.g., Chapter 3), Length of Media Viewed (e.g., 61 min), Total Length of Media (e.g., 122 min), percent viewed-to-total length (e.g., 50.0%), and so on). The metadata associated with the outputted media can be stored as additional data for subsequent comparison with additional metadata as described in greater detail below in conjunction with FIGS. 6B and 6C.

FIG. 3 illustrates an embodiment of warning and status indicators to be displayed on a first display unit. First display unit 314 can include one or more of the examples, descriptions, and/or embodiments of first display unit 14 described above with reference to FIGS. 1A and 1B. First display unit 314 can further include one or more warning indicators 302 and one or more status indicators 304. For example, the apparatus 16 (as shown in FIGS. 1A and 1B) can be adapted to output the media and one or more of a warning indicator 302 and a status indicator 304 if at least a portion of the metadata and the data match as a result of the comparison of the metadata with the data.

Warning indicator 302 can include any text, display, message, cue, signal (audibly-, visually-, or mechanically-based (e.g., vibration) alerting mechanism. The warning indicators 302 and status indicators 304 can be disposed at various locations on the first display unit 314 and displayed at various times and/or frequencies. Several examples of these indicators are provided below, although additional indicators—though not explicitly referenced herein—are contemplated as well.

For example, warning indicator 302 can include a simple warning, display, etc., notifying the end user that the media the end user has attempted to access was outputted, viewed, or the like, at an earlier time. Further, warning indicator 302 can include a detailed summary of what caused the indicator to be displayed (for example, listing one or more of the metadata blocks that matched and/or are associated with the Entry #(as described in greater detail in conjunction with FIGS. 6B and 6C, e.g., the date and time of the previous time or times an end user attempted to view that particular content)). Warning indicator 302 can further include a prompt for verification of an end user (e.g., through a password, biometrics, etc.). Further, warning indicator 302 can include a prompt for payment (such as credit card information) to allow the end user to access the content (e.g., purchase a license to view particular media-based content).

The status indicator 304 can include similar type displays, messages, etc. that output the status of the particular media-based content. For example, the status indicator 304 can display similar content as displayed by warning indicator 302. One difference between the status indicator 304 and the warning indicator 302 is that the status indicator can be used to display, output, etc. information to an end user before the end user attempts to access the media-based content. For example, if an end user “scrolls” over a menu displaying various stored DVR content, the status indicators 304 can be displayed before the end user makes her selection whereas the warning indicators 302 can be displayed as a result of the end user selecting media-based content to view, display, etc.

In this regard, the status indicator 304 can notify an end user of various attributes of that media-based content (e.g., the metadata associated with the media content, including metadata generated as a result of an end user's previous display of that particular media-based content). For example, as an end user scrolls over particular media-based content, status indicator 304 can indicate that end user CEW viewed this particular content on Jan. 31, 2013, on the living room television, on the living room Blu-ray player. This “scrolling” example is discussed in greater detail below.

In other words, the status indicator 304 can quickly and efficiently summarize relevant information (including the media-based content's metadata) for the end user so that she may quickly determine whether or not she would like to view the particular content. In another example, the warning indicators 302 and status indicators 304 can be used to convey information to the end user about upcoming live programming (such as, for example, when the end user searches for future programming that is to be transmitted to the end user at a future time). In this example, an end user can base her decision whether or not to record programming depending upon the output of the one or more warning indicators 302 and status indicators 304 that summarize relevant information related to this particular media-based content.

FIG. 4 illustrates an embodiment of the remote device illustrated in FIG. 1A. Remote device 420 can include one or more of the examples, descriptions, and/or embodiments of first remote device 20 as described above. Remote device 420 can include an input 422, a first signal indicator 424, a second signal indicator 426, an output device 428, and a biometric device 430.

The use of first signal indicator 424, second signal indicator 426, and/or output device 428 can be employed in addition to, or in lieu of, the warning indicator 302, and status indicator 304 (as shown in FIG. 3) to displayed on first display unit 14 (e.g., FIG. 1B). For example, if first signal indicator 424, second signal indicator 426, and/or output device 428 are used in lieu of these warning and signal indicators, an end user can be notified of certain events by the remote device 20 and, thus, such warnings and or indications can be less intrusive to the end user than through the first display unit 14 (e.g., FIG. 1A). Alternatively, one or more of the first signal indicator 424 and second signal indicator 426, the output device 428 can be used in addition to the or more indicators as described in conjunction with FIG. 3.

The input 422 can include a touch-based interface (such as, for example, the input 422 can include a series of buttons, keypads, one or more touchscreens, or other touch-based user interfaces, etc.). As an end user manipulates the input 422, the remote device 420 can transmit one or more signals to one or more devices (such as, for example, one or more elements described in conjunction with FIGS. 1A and 1B) for controlling those devices. For example, input 422 can instruct the first media device 12 (as shown in FIGS. 1A and 1B) to output media stored on it to the first display unit 14 (as shown in FIGS. 1A and 1B).

First and second signal indicators 424 and 426, respectively, can include any display, cue, signal, or the like for providing an audibly-, visually-, or mechanically-based (e.g., vibration) alerting mechanism. For example, in an exemplary and non-limiting illustrative embodiment, first signal indicator 424 can include a visually-based alert (such as, for example, a flashing LED light) to indicate that a match occurred between data and metadata as described in greater detail below in conjunction with FIGS. 6-7.

Similarly, second signal indicator 426 can include an audibly-based alert (such as, for example, a beeping noise) to indicate that a match occurred between data and metadata as described in greater detail below in conjunction with FIGS. 6-7. Alternatively, one or more of the first and second signal indicators can include a motor and or actuator (not shown) for producing a vibration in the remote device 420 to indicate that a match occurred between data and metadata as described in greater detail below in conjunction with FIGS. 6-7.

Remote device 420 can further include an output device 428 for outputting any text, display, message, cue, or signal directly to the end user on the remote device 420. For example, the output device 428 can include an LED or LCD screen, LED display, monitor, or the like. As described in greater detail above, the output device 428 can output or more of the warning indicators and/or status indicators as described with reference to FIG. 3.

Finally, remote device 420 can include biometric device 430. Biometric device 430 can include a retina scan device, finger and/or thumbprint device, or any other device for ascertaining the identity of an end user (e.g., particularly, the one holding the remote device 420) through a biometric-type attribute. With the aid of the biometric device 430, the identity of the end user can be determined such that this information can be used to affect the performance of apparatus 16 (as shown in FIGS. 1A and 1B). For example, apparatus 16 (e.g., FIG. 1B) can be programmed such that only particular end users, as determined by the biometric device 430, can access particular media. In this sense, the biometric device 430 can be used as a security input, code, or the like to gain access to particular media. Also, the biometric device 430 can be used as a filter for certain attributes of metadata.

For example, metadata blocks 206a-g can include the MPPA film ratings. In this example, the biometric device 430 can permit only a particular end user to access media-based content with a rating of “R.” Although not explicitly disclosed, the biometric device 430 can be used to filter other attributes of the metadata (e.g., Output Device ID, particular channel the media-based content was recorded from, etc.). Furthermore, the filters described herein can be applied equally for the facial recognition software referenced with regard to camera 38 (e.g., FIG. 1B). For instance, above-reference filters can be applied on an end user-by-end user basis as determined by camera 38 (as shown in FIG. 1B).

FIG. 5 illustrates an embodiment of the portable apparatus adapted to be used in conjunction with the system for tracking the display of media-based content in real time. The portable apparatus 500 can include a hands-free device 502, a first input device 504, and a transceiver 506.

Hands-free device 504 can include a pair of eyeglasses, an earpiece, or any other device that can be clipped, affixed and/or otherwise coupled to end user. Alternatively, the hand-free device 504 and be a mobile device, such as a device capable of receiving an input of audio and/or video that can be positioned at a location distal from the end user. For example, the hand-free device 504 can be a camera that can include an IPOD® so that the hands-free device 504 can be set on a table or the like.

In the example of the hands-free device embodied as a pair of eyeglasses, an end user can wear the eyeglasses while watching media-based content. By doing so, the input device 504 (e.g., a camera or other video and/or audio recording device) can receive the media-based content and/or associated metadata. Once received, the metadata associated with the media-based content can be stored (e.g., for example, in a storage medium (not shown) located on hands-free device 504), or it can be transmitted by transceiver 506 to a storage medium (not shown), apparatus 16 (as shown in FIGS. 1A and 1B), or another device for receiving data and/or information transmitted by a transmitter, such as transceiver 506.

Transceiver 506 can include a wireless transceiver (e.g., adapted to communicate through one or more wireless protocols, such as BLUETOOTH®, WiFi, etc.) or any other device for communicating and accessing another device through the Internet, internet, intranet, or any other configuration of interconnected devices. For example, transceiver 506 can serve as a relay for relaying information and/or data received by the hands-free device 504 to apparatus 16 (e.g., FIG. 1B). In this example, an end user can employ the hands-free device 504 to track media-based content viewed by the end user while they are located somewhere other than a location that includes the systems, methods, and/or apparatus for tracking media-based content.

For example, if an end user watches a movie with a friend at a friend's house, the hands-free device can track the media-based content viewed by the end user at the friend's house so that she may later relay and/or store the information (e.g., metadata associated with the media-based content) along with the metadata and/or data stored associated with media-based content viewed, outputted, displayed, or the like at her particular home location. This, again, can be accomplished by employing transceiver 506 to transmit the information to a device for receiving, processing, and/or storing the information (e.g., apparatus 16 as shown in FIG. 1B).

FIG. 6A illustrates a flow diagram depicting a first embodiment of exemplary instruction steps of a computer readable storage medium for carrying out a method for tracking the display of media-based content in real time. FIG. 6B illustrates a flow diagram depicting a second embodiment of exemplary instruction steps for carrying out a method for tracking the display of media-based content in real time. FIG. 6C further illustrates the flow diagram depicting the second embodiment of exemplary instruction steps for carrying out a method for tracking the display of media-based content in real time as illustrated in FIG. 6B. These Figures will be described in conjunction with one another.

The computer readable storage medium configured to store a program for tracking the display of media-based content in real time can include a program that is adapted to execute instructions for performing steps 600. The instructions can include the step 602 of receiving metadata associated with media outputted by a first media device, the step 604 of comparing the metadata associated with the outputted media with data, the step 606 of outputting one or more of a warning indicator and a status indicator if at least a portion of the metadata and the data match as a result of the comparing step 604, and the step 608 of displaying the media and the one or more of a warning indicator and a status indicator through a first display unit if the metadata and the data match.

The receiving step 602 can further include storing the metadata associated with the outputted media as additional data for subsequent comparison with additional metadata, and the additional metadata can be adapted to be received upon a request for media to be displayed through the first display unit. The instructions can further include the step 610 of requesting media to be displayed through the first display unit that can be initiated by an end user. The instructions can further include the step 612 of receiving an end user's metadata, wherein the end user's metadata is adapted to be stored with the data and the step 604 of comparing at least one metadata block with the data, wherein the metadata block can include one or more of the following: type of media, title of media, or sub-title of media.

The instructions can further include the step 614 of determining the presence of an end user within a given proximity of the first display unit throughout the display of media and generating data associated with the determination of the end user's presence, the step 616 of generating a report based on the comparing step, wherein the report is adapted to output information from one or more metadata blocks that includes the metadata, and the step 618 of displaying at least a portion of the report through a social media site. Lastly, the displaying step 608 can include prompting a user to enter a password prior to displaying the media and after displaying the one or more of a warning and an indicator.

FIGS. 6B and 6C illustrate an exemplary and non-limiting illustrative embodiment using the example above with reference to FIGS. 2A and 2B (i.e., assuming an end user already watched the movie “American Beauty”) and one additional media-based content. The letter-based labels presented within square brackets within each step of FIG. 6B correspond to the particular illustrations in FIG. 6C. For example, in FIG. 6C, element Aᵢ illustrates a possible arrangement of the metadata associated with the previously viewed “American Beauty” DVD and the metadata of additional media-based content stored in first database 17 (e.g., as shown in FIGS. 1A and 1B) as data (as an initial condition, for example), and element A illustrates a request of media based content referenced in FIG. 6B, step 652.

Referring collectively to FIGS. 6B and 6C, process 650 can include the step 652 of receiving a request for media based content. In this particular example, first database 17 (e.g., FIG. 1A) has already stored the metadata as data associated with the previously displayed media-based content. In this regard, therefore, element A illustrates first database 17 (e.g., FIG. 1A) as only storing two entries (i.e., each entry can be assigned a number in series, e.g., 1, 2, and so on).

Process 650 can include the step 652 of receiving a request for media-based content (illustrated in FIG. 6C as element A). This can include, for example, an end user requesting to watch a particular program. After the request is received, the process 650 can execute the step 654 of receiving metadata associated with the requested media (illustrated in FIG. 6C as element B). For example, the metadata can be received along with the media (as illustrated in element B), or in the alternative, only the metadata can be received. In one example, if media-based content does not include metadata, the apparatus 16 (e.g., as shown in FIG. 1A) can facilitate the generation of metadata to be stored as data. This is discussed in greater detail above with reference to FIGS. 1A and 1B.

Process 650 can further include the step 656 of storing metadata associated with the requested media-based content as data along with previously stored data. For example, FIG. 6C illustrates an example of element C. In this example, the metadata associated with the requested media-based content is stored in element C (e.g., as a data structure).

Although depicted in FIG. 6C as a simple table, this data structure can take many other forms as well. For example, the data can be arranged in any other data structure such as linked lists, b-trees, binary trees, heaps, stacks, queues, hash tables, red-black trees, binomial heaps, Fibonacci heaps, etc. Furthermore, these data can be stored in a Content-Addressable Memory (CAM), or other associative memory, array, storage, or the like. With a CAM memory, for example, all the entries including a particular data word, byte, nibble, etc. can be searched to determine if one or more of the Entry #s match, thus increasing the efficiency of the comparison step 658 as described in greater detail below.

Once stored, the step 658 of comparing the at least one metadata block of the received metadata stored as data with at least a portion of the previously stored data (element D of FIG. 6C) can be performed. In this step, the most recent entry of the database (in this example, the third entry (Entry #3) is compared with the previous two entries). This step 658 of comparing can be accomplished in multiple different ways.

For example, each metadata block can be compared one-by-one through a string compare of other comparison-type algorithm (e.g., compare program). In this example, first the Media Type of Entry #3 will be compared with the Media Type of Entry #2 (e.g., STRM (e.g., abbreviation for streaming) will be compared with the entry “DVR”). In this instance, no match will occur. As shown in the example illustrated in FIG. 6C as element C, no metadata block of Entry #3 matches a metadata block of Entry #2, so a match would not occur in this instance. However, once the comparison of Entry #3 with Entry #2 is complete, a comparison of Entry #3 with Entry #1 can begin (or, in the alternative, two or more comparisons can be performed in parallel rather than the through the sequential comparison process described above). In this instance, the Media Title metadata block would result in a match because both entries are for the movie, “American Beauty.” These comparisons will continue until all previous entries are compared with the most recent entry (e.g., there will be at least N−1 comparisons, where N=the Entry # of the most recent entry). In another example, the comparison process can complete after a match occurs without comparing the remaining entries. Of course, the comparison can equally start with Entry #1 as well, and work its way through each entry further down in the database (e.g., Entry #1, Entry #2, and so on).

If at least once match occurs, the step 660 of outputting one or more of a warning indicator and a status indicator if at least a portion of the metadata and the data match can be performed, otherwise the process will end, as illustrated in the logical branch illustrated as element E of FIG. 6C. The process 650 can be implemented in multiple different ways for the step 660 of outputting the indicators. For example, more than one match may need to occur before the step 660 occurs (e.g., at least two metadata blocks match between the current Entry # and one of the previously stored Entry #s. Moreover, certain metadata block fields can be ignored even if a match occurs.

For example, an end user may wish to ignore the Media Type field if a match occurs with this field. This is because often there are multiple unrelated media-based content that can be accessed through the same media device (e.g., a DVR unit). Accordingly, one or more of the metadata blocks can be stored for recordkeeping and/or informational purposes (including as a portion of the indicators as well) and, thus, can be ignored while determining whether or not to trigger the step 660 of outputting the indicators. With this in mind, an end user can set preferences such that the step 658 of comparing will only occur on particular metadata blocks, while ignoring the others to increase the speed and efficiency of the comparisons step.

Further, the step 658 of comparing can be custom-tailored to trigger the step 660 of outputting the one or more indicators. For example, the Date/Time field (or other fields, for example the End User, Output Device, etc.) can be used as one or more filters for trigging the step 658 of comparing. For example, the Date/Time Stamp of a particular entry might be: Jan. 21, 2009, 16 hr, 30 min. In other words, the particular entry was stored on Jan. 21, 2009, at 4:30 pm. The Date/Time Stamp can be used to filter out any comparisons that occurs within a particular time period so that they may be ignored if they meet a particular criterion. For example, if the filter is set to two years or less, and the same media is viewed on Jan. 21, 2013, the outputting step 660 would not be triggered even though a match occurred for this media (e.g., Media Title) because it was previously viewed, displayed, outputted, or the like more than two years from the previous entry. Although not specifically referenced here, other filters are contemplated as well.

In another example, the step 660 of outputting one or more of an indicator can be triggered based on a successful comparison (i.e., match) of the step 658 of comparing the received metadata before an end user requests to view and/or display the media-based content. In this example, the step 652 of receiving a request for media-based content can include merely the step of an end user scrolling through a menu of previously recorded media (e.g., television shows stored on a DVR device). Moreover, the action of scrolling over a particular menu item summarizing particular media-based content can include the receiving step 652 of requesting media-based content. In this example, this scrolling action (for example) can trigger the receiving metadata step 654, and the comparing step 658 without the need to store the metadata. In other words, the metadata associated with that particular item can be compared before an end user desires to output it to a device, such as the first display unit 14 (e.g., FIG. 1A) so that a determination can be made whether or not that particular media-content has been previously outputted.

The step 660 of outputting can include outputting one or more of a warning indicator and a status indicator. As discussed in greater detail previously, these indicators can be outputted to one or more of the element illustrated in FIGS. 1A and 1B (e.g., these indicators can be outputted to the remote device 20, the first display unit 14, etc.). The types of indicators and the information, data, and the like that can be communication through these indicators are also discussed above, with specific reference to FIG. 3.

Whether the process ends as a result of no match, or if the step 660 of outputting one or more of a warning indicator and a status indicator as a result of a match, the process can repeat back to the step 652 of receiving a request for media-based content (as illustrated in FIG. 6C as element A). In another embodiment, the comparison step 658 can occur before the storing step 656. In this example, as the metadata is received, but before it is stored, it can be compared with the data (e.g., the data shown in data structure C). This example is particularly useful because the end user can be notified of a potential match even before particular media-based content is stored. That is, for example, if a DVR device is scheduled to record a show that would, if stored, generated a match, then one or more indicators can be displayed before the media-based content begins and/or concludes being stored to the DVR device, thus maximizing its storage capacity.

FIG. 7 illustrates a flow diagram depicting a method for tracking the display of media-based content in real time. The method 700 for tracking the display of media-based content in real time can include the step 702 of receiving media from a first server through a network, wherein the received media can be adapted to be stored in a first computer readable storage medium on a first media device. The method can further include the step 704 of requesting the received media to be displayed through a first display unit, wherein the requesting step can be performed by an end user's operation of a remote device. Still further, the method can include the step 706 of receiving metadata associated with the received media stored in the first computer readable storage medium and the step 708 of comparing the metadata associated with the received media with data stored in a second computer readable medium to determine whether or not at least a portion of the metadata and the data match.

Furthermore, the method 700 can include the step 710 of outputting one or more of a warning indicator and a status indicator if at least a portion of the metadata and the data match as a result of the comparing step and the step 712 of displaying the media and the one or more of a warning indicator and a status indicator through a first display unit if and only if the metadata and the data match. Finally, the method can include the step 714 storing the data in the second computer readable storage medium as additional data irrespective of whether or not at least a portion of the metadata and the data match wherein the data and the additional data can be adapted to be compared with the additional metadata upon a subsequent request to receive media to be displayed through the first display unit.

Although not explicitly recited throughout the description related to the process steps set forth in FIGS. 6-7, certain aspects of the inventions that are described in conjunction with the apparatuses and systems above (such as, for example, a particular function of element) can be carried out as one or more process steps and/or instructions adapted to executed those one or more process steps. For example, with regard to the description of apparatus 16 (as shown in FIGS. 1A, 1B), the apparatus 16 is described as having the ability populate entered data into a first database 17 (e.g., “if the end user can manually enter the movie title into the apparatus 16 while in input mode, and the apparatus 16 can populate the entered data into the first database 17 as data that can be compared with a subsequent request for media-based content.”).

The inventions described herein, therefore, can include the step, for example, of “populating entered data into a first database as data that can be compared with a subsequent request for media-based content.” Accordingly, several steps contemplated and supported by the descriptions of particular systems and apparatuses disclosed throughout have not been repeated with regard to process-related descriptions (e.g., FIGS. 6-7) in the interest of clarity and brevity.

As used throughout the description herein, the term “real time” can include “within a particular time constraint.” In an exemplary and non-limiting illustrative embodiment, “tracking the display of media-based content in real time” can include tracking the display contemporaneously (e.g., streaming) as it is being outputted, displayed, or the like. Alternatively, using the same example, “tracking the display of media-based content” can include waiting until a portion of the media-based content (or the entire media-based content) is displayed, outputted, or the like, and then tracking the display. For example, if the media-based content being displayed is a DVD, the tracking can occur in “real time” on a chapter-by-chapter basis of the DVD (i.e., each time a new chapter of the movie begins and/or ends, the display of that particular chapter can be tracked in accordance with the inventions described herein).

The term “coupled,” “coupling,” “coupler,” and like terms are used broadly herein and can include any method or device for securing, binding, bonding, fastening, attaching, joining, inserting therein, forming thereon or therein, or otherwise associating, for example, mechanically, magnetically, electrically, chemically, operably, directly or indirectly with intermediate elements, one or more pieces of members together and can further include without limitation integrally forming one functional member with another in a unitary fashion. The coupling can occur in any direction, including rotationally.

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment.

Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the Figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

Other and further embodiments utilizing one or more aspects of the inventions described above can be devised without departing from the spirit of Applicant's invention. It should be appreciated by those of skill in the art that the techniques disclosed in the disclosed embodiments represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention. Other variations of the systems, apparatuses, and methods can be included in combination with each other to produce variations of the disclosed embodiments. Discussion of singular elements can include plural elements and vice-versa.

In some alternate implementations, the functions/actions/structures noted in the Figures can occur out of the order noted in the block diagrams and/or operational illustrations. For example, two operations shown as occurring in succession, in fact, can be executed substantially concurrently or the operations can be executed in the reverse order, depending upon the functionality/acts/structure involved. For example, FIG. 3 illustrates one possible embodiment of a method for delivering advertising-based content. More specifically, FIG. 6 recites the step 610 of requesting media to be displayed through the first display unit after the step 602 of receiving metadata associated with media outputted by a first media device. Other embodiments can include performing step 610 before step 602. In some embodiments, some steps can be omitted altogether. Therefore, though not explicitly illustrated in the Figures, any and all combinations or sub-combinations of the steps illustrated in FIGS. 6-7 or additional steps described in the Figures or the detailed description provided herein, can be performed in any order, with or without regard for performing the other recited steps.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicant intends to fully protect all such modifications and improvements that come within the scope or range of equivalent of the following claims.

What is claimed is:

1. A computer readable storage medium configured to store a program for tracking the display of media-based content in real time, wherein the program is adapted to execute instructions for performing the following steps, comprising:
receiving metadata associated with media outputted by a first media device;
comparing the metadata associated with the outputted media with data;
outputting one or more of a warning indicator and a status indicator if at least a portion of the metadata and the data match as a result of the comparing step; and
displaying the media and the one or more of a warning indicator and a status indicator through a first display unit if the metadata and the data match.

2. The computer readable storage medium according to claim 1, wherein the receiving step further comprises storing the metadata associated with the outputted media as additional data for subsequent comparison with additional metadata.

3. The computer readable storage medium according to claim 2, wherein the additional metadata is adapted to be received upon a request for media to be displayed through the first display unit.

4. The computer readable storage medium according to claim 1, wherein the comparing step further comprises comparing at least one metadata block with the data, wherein the metadata block comprises one or more of the following: type of media, title of media, or sub-title of media.
